(19) United States
(12) Patent Application Publication
(10) Pub. No.: US 2017/0183587 A1
(43) Pub. Date: Jun. 29, 2017

(54) POLYHYDRIC ALCOHOL COMPOSITIONS FOR GAS DEHYDRATION

(71) Applicant: Dow Global Technologies LLC, Midland, MI (US)

(72) Inventors: Christophe R. Laroche, Lake Jackson, TX (US); Eric J. Klinker, Lake Jackson, TX (US)

(73) Assignee: Dow Global Technologies LLC, Midland, MI (US)

(21) Appl. No.: 15/313,721

(22) PCT Filed: Jun. 11, 2015
(86) PCT No.: PCT/US2015/035239

§ 371 Date: Nov. 23, 2016

Related U.S. Application Data
(60) Provisional application No. 62/014,862, filed on Jun. 20, 2014.

(51) Int. Cl. C10L 3/10; B01D 53/26; B01D 53/28

(52) U.S. Cl. CPC C10L 3/106; B01D 53/28; B01D 53/263; B01D 2252/2023

(57) ABSTRACT

The present invention relates to a dehydration composition and method of use thereof for drying gas streams, in particular natural gas streams, wherein the dehydration composition comprises one or more polyhydric alcohol. Said polyhydric alcohol preferably has a hydroxyl content equal to or greater than 31 percent and equal to or less than 75 percent of the formula weight of the compound. Said polyhydric alcohol dehydration compositions are particularly suitable for dewatering and desalting gas stream comprising water and one or more salt.

### FIELD OF THE INVENTION

The present invention relates to a composition and method of use thereof for drying gas streams, in particular natural gas streams, wherein the composition comprises one or more polyhydric alcohol. Said polyhydric alcohol compositions are particularly suitable for dewatering and desalting gas stream comprising water and one or more salt.

### BACKGROUND OF THE INVENTION

Gases, such as natural gas, generally contain varying amounts of water vapor. It is desirable that no water vapor be admitted to a natural gas pipeline. The presence of the water vapor is undesirable as the water vapor can result in corrosion of pipes and cause corrosion of, and stoppages in, valves and fittings in gas pipe transmission systems. Further, quantities of water or moisture that are relatively small may freeze and block the pipeline such that flow is completely halted or at least greatly restricted.

Additionally, freshly extracted natural gas may contain sizeable amounts of salts which are mostly in the form of sodium chloride and/or calcium chloride, but which are also present as other species. The corrosive action of salts on pipes and other facilities is well known to the gas-refining industry. Thus, the removal of water and salts from natural gas is commonly an integral function of any gas processing plant.

A common method for removing moisture from gas streams, such as natural gas, is to use a gas dehydration unit using a glycol as a solvent. In such a unit, the wet gas is contacted with a lean glycol in an absorbent step to remove the water. The glycol commonly used is triethylene glycol (TEG) and to a lesser extent other glycols such as diethylene glycol (DEG) or ethylene glycol (EG). The rich glycol (i.e., glycol containing the water) is then passed to a reconcentration or regeneration process typically comprising a reboiler wherein the absorbed water is driven off and removed, thereby enabling reuse of the regenerated glycol.

A troublesome problem arises herein, however, in that, although the reboiler can easily drive off water, the salts remain in the regenerated glycol. The regenerated glycol may take several trips through the loop before reaching its saturation point with respect to the salts. Salts may crystallize out settling onto the heating pipes in the reboiler forming a heat-insulating layer therein, and/or foul the transport piping associated with the regeneration process. Ultimately, the reboiler and/or heat exchangers become so encrusted or corroded that the entire gas processing operation must be shut down and they must be dismantled and cleaned or repaired. Shutdowns are very costly is as well discarding and replacing thousands of gallons of glycol.

Due to seasonal demands, freshly extracted natural gas is frequently initially stored in so-called “salt domes”, i.e., giant cavities which have been artificially eroded into salt deposits by means of water and steam to depths of thousands of feet and diameters on the order of miles. The gas stored in these giant sodium chloride containers picks up even more salt and accordingly exacerbates the down-time problems at gas processing plants when it is re-extracted and processed.

Therefore, there still exists a need for an improved solution to the technological problems created by the presence of salts in natural gas. While methods of desalting glycol solvents such as triethylene glycol are known, for example using ion exchange resins, no satisfactory solution has yet been discovered. Alternatively, it would be desirable to find a solvent composition for dehydrating a gas having an improved solubility of salts, specifically sodium and calcium chlorides, wherein said solvent composition can reduce the problems associated with existing glycol solvents, specifically triethylene glycol.

### SUMMARY OF THE INVENTION

The present invention is a polyhydric alcohol dehydration composition and use thereof for removing water from a gas, preferably natural gas, comprising water or water and salt wherein the polyhydric alcohol dehydration composition comprises one or more of the compounds represented by the following formulas:

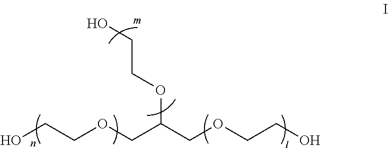

wherein (l+m+n) is equal from 0 to 2,

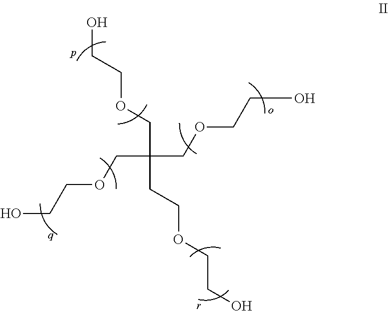

wherein (o+p+q+r) is equal from 0 to 3,

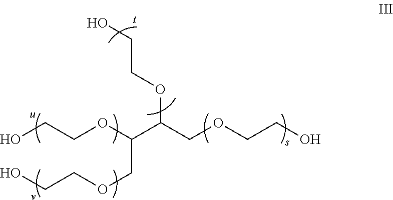

wherein (s+t+u+v) is equal from 0 to 3,

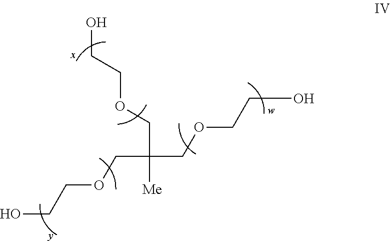

wherein (w+x+y) is equal from 0 to 3,
or

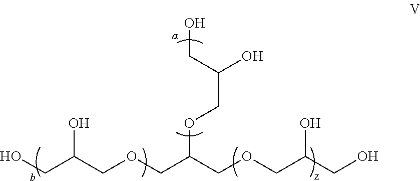

wherein (z+a+b) is equal from 0 or 3.

Preferably, the polyhydric alcohol dehydration composition disclosed herein above further comprises one or more of ethylene glycol, diethylene glycol, triethylene glycol, or tetraethylene glycol, more preferably one or more of an alkanolamine, a phosphate compound, or a borate compound.

### DETAILED DESCRIPTION OF THE INVENTION

The polyhydric alcohol dehydration compositions of the present invention may be used to remove water from any gas comprising water, they are particularly suited for removing water and salts from any gas comprising water and salts, and are particularly suited for use with raw and/or treated natural gas. Raw natural gas comes from three types of wells: oil wells, gas wells, and condensate wells. Natural gas that comes from oil wells is typically termed “associated gas”. This gas can exist separate from oil in the formation (free gas), or dissolved in the crude oil (dissolved gas). Natural gas from gas and condensate wells, in which there is little or no crude oil, is termed “non-associated gas”. Gas wells typically produce raw natural gas by itself, while condensate wells produce free natural gas along with a semi-liquid hydrocarbon condensate. Whatever the source of the natural gas, once separated from crude oil (if present) it commonly exists as a mixture of methane and other hydrocarbons, water, salts, and other impurities, such as acid gases. The term “natural gas” as used herein below includes any natural gas source comprising water and salts including raw or treated natural gas. Treated natural gas is raw natural gas that has been treated one or more times to remove one or more impurities.

The polyhydric alcohol dehydration composition of the present invention is a liquid comprising one or more of the polyhydric alcohols represented by the following formulas:

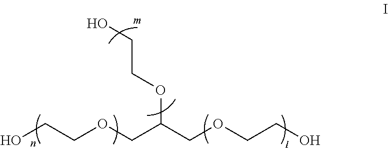

wherein (l+m+n) is equal from 0 to 2,

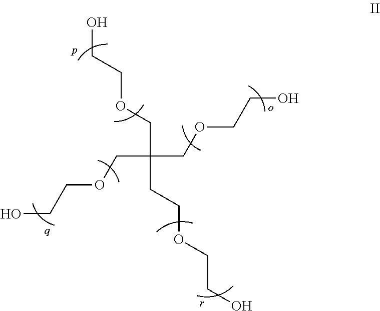

wherein (o+p+q+r) is equal from 0 to 3,

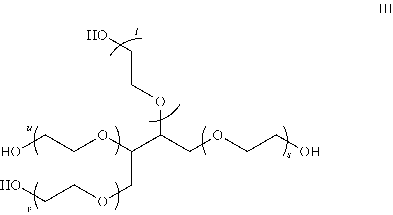

wherein (s+t+u+v) is equal from 0 to 3,

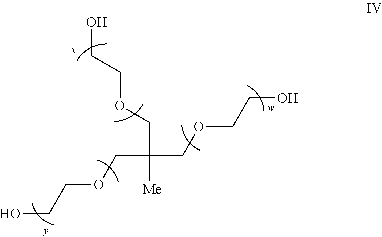

wherein (w+x+y) is equal from 0 to 3,
or

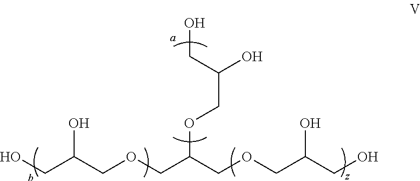

wherein (z+a+b) is equal from 0 or 3.

In addition to comprising one or more of the polyhydric alcohols of formulas I to V, the polyhydric alcohol dehydration compositions of the present invention may further comprise a diol of the formula:

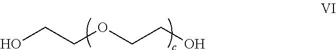

wherein c is equal to 0 to 3.

Polyhydric alcohols of the present invention preferably have a hydroxyl content where the hydroxyl component (—OH) equal to or greater than 31 percent of the formula weight of the compound (i.e., hydroxyl content=compound Mw/#—OH groups). Preferably the high hydroxyl content compounds have greater than 34 percent formula weight of hydroxyl content. More preferably the high hydroxyl content compounds have greater than 40 percent formula weight of hydroxyl content. Polyhydric alcohols of the present invention preferably have a hydroxy content equal to or less than 75.

Polyhydric alcohols of the present invention preferably have a boiling point of equal to or greater than 195° C., more preferably equal to or greater than 245° C., more preferably equal to or greater than 290° C., more preferably equal to or greater than 345° C., and more preferably equal to or greater than 390° C.

If the polyhydric alcohol dehydration composition of the present invention comprises VI (e.g., one or more of ethylene glycol, diethylene glycol, triethylene glycol, and tetraethylene glycol) VI is present in an amount equal to or greater than 1 weight percent, preferably equal to or greater than 5 weight percent, more preferably equal to or greater than 10 weight percent, more preferably equal to or greater than 20 weight percent, more preferably equal to or greater than 30 weight percent, more preferably equal to or greater than 40 weight percent wherein weight percent is based on the total weight of the polyhydric alcohol dehydration composition. If the polyhydric alcohol composition of the present invention comprises VI (one or more of ethylene glycol, diethylene glycol, and triethylene glycol) VI is present in an amount equal to or less than 99 weight percent, preferably equal to or less than 95 weight percent, more preferably equal to or less than 90 weight percent, more preferably equal to or less than 80 weight percent, more preferably equal to or less than 70 weight percent, more preferably equal to or less than 60 weight percent, more preferably equal to or less than 50 weight percent wherein weight percent is based on the total weight of the polyhydric alcohol dehydration composition.

The polyhydric alcohol dehydration composition of the present invention may further comprise one or more common dehydration composition ingredient such as a buffering agent, for example alkanolamines such as monoethanolamine (MEA), diethanolamine (DEA), methyldiethylanolamine (MDEA), or triethanolamine (TEA), see U.S. Pat. No. 3,349,544 which is incorporated by reference herein in its entirety; a phosphate acid or salt compound, such as phosphoric acid, potassium phosphate, dipotassium phosphate, disodium phosphate, or trisodium phosphate, see U.S. Pat. No. 2,384,553 which is incorporated by reference herein in its entirety; or a borate acid or salt compound, such as boric acid, sodium tetraborate, see U.S. Pat. No. 4,758,367 which is incorporated by reference herein in its entirety; a sweetening agent, such as an alkanolamine, a sulfolane, ethers of polyethylene glycol; or a low temperature viscosity improver, for example propylene carbonate, dimethylformamide or N-substituted morpholine compounds. Preferably, these ingredients are used independently in an amount of from 0.01 weight percent to 25 weight percent based on the total weight of the polyhydric alcohol dehydration composition.

The polyhydric alcohol dehydration composition of the present invention may further comprise a corrosion inhibitor, an antifoaming agent, and mixtures thereof. Any suitable corrosion inhibitor or antifoaming agent typically used in such dehydration applications may be used in the composition and method of the present invention.

Further, the polyhydric alcohol dehydration composition of the present invention may further comprise antifoaming agents consistent with the environment of use. Exemplary antifoaming agents used include silicone based defoamers and EO/PO based defoamers such as polysiloxane and polypropylene glycol copolymers. Typically, such antifoaming agents are useful concentrations of about 10 ppm to 200 ppm.

The polyhydric alcohol dehydration composition of the present invention is useful in a process for removing water from a gas comprising water, preferably a gas comprising water and one or more salt. A typical process for removal of water and/or water and salts from a gas, such as natural gas comprising water and/or salts comprises an absorber equipped with baffles, trays, random packing, structured packing, or combination thereof. Natural gas arriving is admitted into the bottom of the absorber and up flows toward the top. At the same time a lean polyhydric alcohol dehydration composition of the present invention is admitted continuously into the top of the absorber and trickles downwardly over the baffles in countercurrent exchange with the up flowing gas. The net result is that the water and/or salts in the gas are exposed to and preferentially partition into the more polar polyhydric alcohol solution such that the gas exiting at the top of the absorber is substantially free of water and/or salts and the polyhydric alcohol solution exiting the bottom of the absorber is rich with these contaminants.

Water and/or salt-laden rich polyhydric alcohol solution of the present invention is pumped through a closed-loop (of which the absorber is part) including various filters, strippers, heat exchangers, etc., and a reboiler wherein the polyhydric alcohol solution of the present invention is conventionally heated and maintained at a temperature of from about 250° F. to about 400° F. such that the water is driven off. The resulting lean regenerated polyhydric alcohol solution of the present invention may then be returned through the remaining portion of the loop back to the absorber, again to flow in countercurrent exchange with natural gas comprising water and/or salts.

### Examples

The following polyhydric alcohols are evaluated for salt solubility:

“GLY” is glycerol of 99.8 wt % purity available from Fisher;

“TEG” is triethylene glycol available from Fisher;

“MEG” is monoethoxylated glycerol (formula I where 1+m+n=1) is the reaction product of adding 0.8 molar equivalent of ethylene oxide to a mixture of 99.8 wt % purity glycerol and potassium hydroxide (1000 ppm) at 120° C.;

“BEG” is bisoethoxylated glycerol (formula I where 1+m+n=2) is the reaction product of adding 2 molar equivalent of ethylene oxide to a mixture of 99.8 wt % purity glycerol and potassium hydroxide (1000 ppm) at 120° C.; and

“DG” is diglycerol (formula III where s+t+u+v=1) available from TCI.

### Chloride Ion Analysis.

Chloride ion is analyzed using an ion chromatography system comprising a Dionex DX-500 IC 701 equipped with a guard column (Ion Pac AG5A-5 μm, PN037134 (Dionex)), an analytical Column (Ion Pac AS5A-5 μm, PN037131 (Dionex)), a suppressor (ASRS-Ultra II 4 mm Membrane Suppressor, PN 064554 (Dionex)) and an eluent Generator (EluGen Cartridge (EGCII KOH, PN058900 (Dionex)).

### Salt Solubility.

The Comparative Example A comprises triethylene glycol (TEG) and Example 1 comprises a 1:1 ratio of triethylene glycol to glycerol (TEG:GLY). For each Example 1 and Comparative Example A, 10 grams of salt (sodium chloride or calcium chloride) is added to a 250 mL round bottom flask with 100 g of polyhydric alcohol composition. The sodium chloride solutions are stirred under nitrogen at three temperatures, at 210° F., 300° F., and 350° F., for one hour and the calcium chloride solutions are stirred at 68° F. for one hour. After equilibration, the agitation is stopped and an aliquot of solution is withdrawn from the supernatant and the concentration of chloride ion is determined by ion chromatography. The results for Examples 1 and Comparative Example A are reported in Table 1.

TABLE 1

| | 68° F. | 210° F. | 300° F. | 350° F. |
|---|---|---|---|---|
| Com Ex A | | | | |
| NaCl, wt % | | 1.59 | 0.74 | 0.56 |
| CaCl_{2,} wt % | 0.45 | | | |
| Ex 1 | | | | |
| NaCl, wt % | | 4.8 | 4.05 | 3.61 |
| CaCl_{2,} wt % | 7.14 | | | |

For Examples 2 to 4 and Comparative Example B each polyhydric composition is stirred with 20 wt % of NaCl at 100° C. for 2 hours. The stirring is stopped to let the NaCl settle for 15 minutes. Then, 0.1 g of solution is transferred into a tarred container then diluted to 20 g using distilled water. The sample is then analyzed by ion chromatography for chloride content and the results are reported in Table 2.

TABLE 2

| | | Chloride | NaCl | | Boiling |
|---|---|---|---|---|---|
| | | Concentra- | concentra- | Hydroxyl | Point, |
| Example | Glycol | tion (ppm) | tion (wt %) | Content | ° C. |
| Com Ex B | TEG | 10911 | 1.80 | 75 | 285 |
| Ex 2 | MEG | 22265 | 3.67 | 45 | 328 |
| Ex 3 | BEG | 13533 | 2.23 | 60 | 345 |
| Ex 4 | DG | 16362 | 2.70 | 42 | 407 |

What is claimed is:

1. A polyhydric alcohol dehydration composition for the removal of water from a gas comprising one or more of the compounds represented by the following formulas: 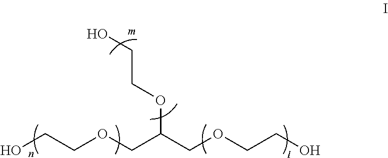
wherein (l+m+n) is equal from 0 to 2, 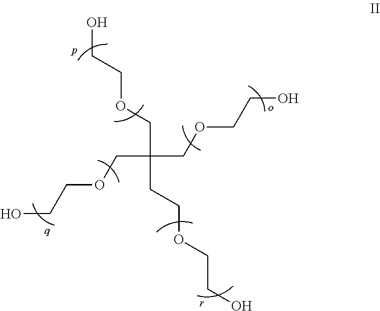
wherein (o+p+q+r) is equal from 0 to 3, 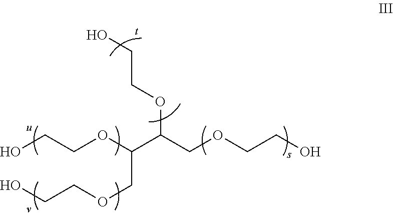
wherein (s+t+u+v) is equal from 0 to 3, 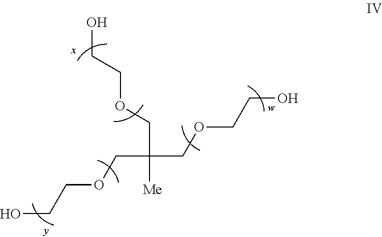
wherein (w+x+y) is equal from 0 to 3,
or 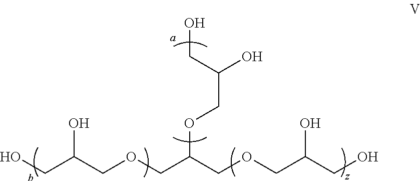
wherein (z+a+b) is equal from 0 or 3.

2. The polyhydric alcohol dehydration composition of claim 1 further comprising one or more of ethylene glycol, diethylene glycol, triethylene glycol, or tetraethylene glycol.

3. The polyhydric alcohol dehydration composition of claims 1 and 2 further comprising one or more of an alkanolamine, a phosphate compound, or a borate compound.

4. The polyhydric alcohol dehydration composition of claims 1 to 3 further comprising one or more of a buffering agent, a sweetening agent, a low temperature viscosity improver, a corrosion inhibitor, or an antifoaming agent.

5. A process for removing water from a gas comprising water using a polyhydric alcohol dehydration composition comprising one or more of the compounds represented by the following formulas: 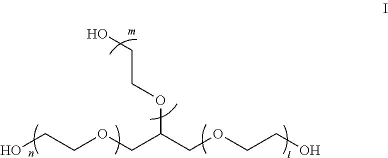
wherein (l+m+n) is equal from 0 to 2, 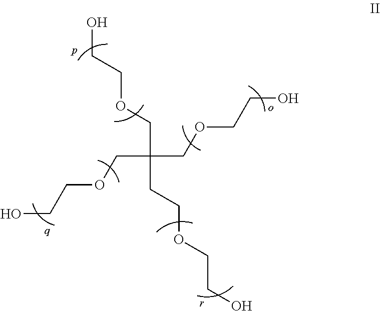
wherein (o+p+q+r) is equal from 0 to 3, 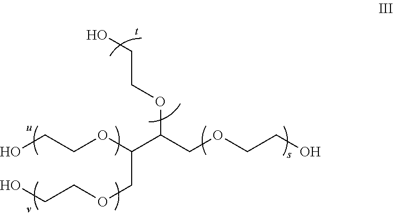
wherein (s+t+u+v) is equal from 0 to 3, 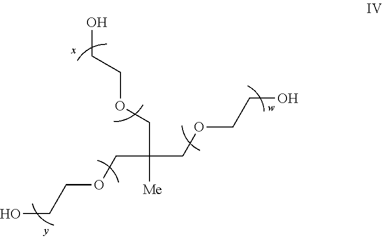
wherein (w+x+y) is equal from 0 to 3,
or 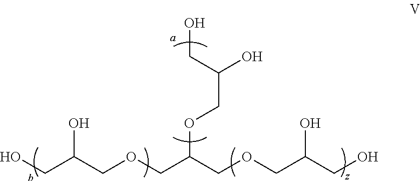
wherein (z+a+b) is equal from 0 or 3.

6. The process of claim 5 wherein the polyhydric alcohol dehydration composition further comprises one or more of ethylene glycol, diethylene glycol, triethylene glycol, or tetraethylene glycol.

7. The process of claims 5 and 6 wherein the polyhydric alcohol dehydration composition further comprises one or more of an alkanolamine, a phosphate compound, or a borate compound.

8. The process of claims 5 to 7 wherein the polyhydric alcohol dehydration composition further comprises one or more of a buffering agent, a sweetening agent, a low temperature viscosity improver, a corrosion inhibitor, or an antifoaming agent.

9. The process of claim 5 wherein the gas further comprises one or more salt.

10. The process of claim 5 wherein the gas is natural gas.
